(19) United States
(12) Patent Application Publication
(10) Pub. No.: US 2010/0255255 A1
(43) Pub. Date: Oct. 7, 2010

(54) SHEET FOR BARRIER LEG CUFF

(75) Inventors: Yoshihisa Kawakami, Mie (JP); Akio Matsubara, Chiba (JP)

Correspondence Address: BUCHANAN, INGERSOLL & ROONEY PC, POST OFFICE BOX 1404, ALEXANDRIA, VA, 22313-1404, US

(73) Assignee: Mitsui Chemicals Inc., Tokyo (JP)

(21) Appl. No.: 12/742,359

(22) PCT Filed: Nov. 12, 2008
(86) PCT No.: PCT/JP2008/070564

§ 371 Date: May 11, 2010

(30) Foreign Application Priority Data
Nov. 12, 2007 (JP) 2007 293765
Nov. 13, 2007 (JP) 2007294957

(51) Int. Cl. B32B 3/30; D04H 13/00; B32B 5/00; B32B 5/26; B32B 7/02

(52) U.S. Cl. 428/156; 442/327; 428/219; 442/381; 428/212

(57) ABSTRACT

There is provided a sheet for barrier leg cuffs for use in absorbent products, such as disposal diapers. The sheet has excellent air permeability and is highly effective in preventing the leakage of loose feces. The sheet for barrier leg cuffs is made from a continuous-fiber nonwoven fabric having a ratio of thickness to basis weight equal to or higher than 0.015 mm/(g/m²). Preferably, the sheet for barrier leg cuffs is made from a continuous-fiber nonwoven fabric containing a fiber mixture of thermoplastic elastomer continuous fiber and extensible continuous fiber. The sheet for barrier leg cuffs according to the present invention has air permeability, is highly effective in preventing the leakage of loose feces, and is flexible and hence excellent in terms of feel against skin; thus, it can be suitably used in barrier leg cuffs of disposable diapers, sanitary products, and other absorbent products.

### TECHNICAL FIELD

The present invention relates to a sheet for barrier leg cuffs of disposable diapers and other absorbent products; it is excellent in terms of air permeability and performance in preventing the leakage of loose feces.

### BACKGROUND ART

An absorbent product, such as a disposable diaper, is equipped with a liquid-permeable top sheet, a liquid-impermeable back sheet, and an absorbent sandwiched between these sheets and has barrier leg cuffs arranged on the left and right sides thereof for preventing urine, feces, or body fluid from leaking out.

The above-described barrier leg cuffs for disposable diapers or the like are required not only to prevent the leakage of urine and other fluids as described above but also to be excellent in terms of air permeability; thus, materials used for them include nonwoven fabric in most cases. Various methods have been proposed as methods for manufacturing sheets used in such barrier leg cuffs (sheets for barrier leg cuffs). Specific examples include the method proposed in Japanese Unexamined Patent Application Publication No. H8-215245 (Patent Document 1), in which a composite sheet containing a polyethylene sheet and nonwoven fabric with a basis weight in the range of 10 to 25 g/m² is used, the method proposed in Japanese Unexamined Patent Application Publication No. 2003-299694 (Patent Document 2), in which spunbonded nonwoven fabric, air-through nonwoven fabric, or spunbonded/melt-blown/spunbonded nonwoven fabric (SMS or SMMS) is used, and the method proposed in Japanese Unexamined Patent Application Publication No. 2007-29610 (Patent Document 3), in which card-embossed nonwoven fabric, air-through nonwoven fabric, or some other kind of water resistance nonwoven fabric or similar nonwoven fabric is used, the nonwoven fabric mainly containing polypropylene such as PP-SB (polypropylene spunbonded nonwoven fabric), PP-SMS (polypropylene spunbonded/melt-blow/spunbonded-laminated nonwoven fabric), or PP-SMMS (polypropylene spunbonded/melt-blow/melt-blown/spunbonded-laminated nonwoven fabric) and having a basis weight in the range of 13 to 25 g/m².

However, the composite film in which a polyethylene sheet and nonwoven fabric are laminated, disclosed in the description of Patent Document 1, is inferior in air permeability. On the other hand, the nonwoven fabric laminates of melt-blown nonwoven fabric and nonwoven fabric, such as SMS or SMMS, disclosed in the description of Patent Documents 2 and 3 have better air permeability than polyethylene sheets; however, they have problems such as potential leakage of loose feces. As can be seen from the foregoing, sheets for barrier leg cuffs that can prevent the leakage of loose feces while retaining air permeability have not been obtained yet.

[Patent Document 1] Japanese Unexamined Patent Application Publication No. 8-215245

[Patent Document 2] Japanese Unexamined Patent Application Publication No. 2003-299694

[Patent Document 3] Japanese Unexamined Patent Application Publication No. 2007-29610

### DISCLOSURE OF INVENTION

### Problems to be Solved by the Invention

An object of the present invention is to provide a sheet for barrier leg cuffs of disposable diapers and other absorbent products; the sheet for barrier leg cuffs is excellent in terms of air permeability and performance in preventing the leakage of loose feces.

### Means for Solving the Problems

The present invention provides a sheet for barrier leg cuffs that contains continuous-fiber nonwoven fabric in which the ratio of the thickness to the basis weight is 0.015 mm/(g/m²) or higher.

### EFFECT OF THE INVENTION

The sheet for barrier leg cuffs according to the present invention is excellent in terms of air permeability, performance in preventing the leakage of loose feces, and is flexible and hence excellent in terms of feel against skin; thus, it is suitable for use as barrier leg cuffs of disposable diapers, sanitary products, and other absorbent products.

### BRIEF DESCRIPTION OF THE DRAWINGS

FIG. 1 is a schematic diagram showing the slit arrangement of the spinneret for eccentric hollow conjugated continuous fiber used in an example of the present invention.

FIG. 2 is an overview of the spunbonding apparatus used in examples and comparative examples of the present invention.

FIG. 3 is a schematic diagram showing an example cross-section of eccentric hollow conjugated continuous fiber used in an example and a comparative example of the present invention. In this drawing, the white and black areas represent resins used in combination, a represents the thickness of the higher melting-point thermoplastic resin, and b represents the thickness of the lower melting-point thermoplastic resin.

FIG. 4 is a schematic diagram showing a cross-section of hollow conjugated continuous fiber used in a comparative example of the present invention. In this drawing, the white and black areas represent resins used in combination.

FIG. 5 is a schematic diagram showing a cross-section of crimped conjugated continuous fiber used in a comparative example of the present invention. In this drawing, the white and black areas represent resins used in combination.

FIG. 6 is a schematic diagram showing a cross-section of hollow conjugated continuous fiber used in a comparative example of the present invention. In this drawing, the white and black areas represent resins used in combination.

FIG. 7 includes schematic diagrams showing an embodiment of uniform drawing of a fiber mixture used in the present invention.

### BEST MODE FOR CARRYING OUT THE INVENTION

The sheet for barrier leg cuffs according to the present invention contains bulky continuous-fiber nonwoven fabric, and the continuous-fiber nonwoven fabric is usually continuous-fiber nonwoven fabric (A) containing crimped fiber or continuous-fiber nonwoven fabric (B) containing a fiber mixture.

<Continuous-Fiber Nonwoven Fabric>

The continuous-fiber nonwoven fabric contained in the sheet for barrier leg cuffs according to the present invention is continuous-fiber nonwoven fabric (A) containing crimped fiber or continuous-fiber nonwoven fabric (B) containing a fiber mixture.

The above-mentioned crimped fiber is a fiber containing one or more polymers chosen from thermoplastic resin (i), thermoplastic elastomer (ii), and other similar materials,

whereas the above-mentioned fiber mixture is a fiber mixture obtained by mixing extensible continuous fiber and thermoplastic elastomer fiber.

<Thermoplastic Resin (i)>

In the present description, thermoplastic resins are resins that have a nature of softening under heat without chemical reaction and returning to the solid form under cooling and reversibly undergo this phenomenon on repeated heating and cooling, excluding the thermoplastic elastomer polymers described later. Examples of the thermoplastic resin (i) will be described later.

On the other hand, the thermoplastic elastomers are resins that have a nature of melting under heat and hardening under cooling and develop rubber elasticity (elastomeric properties) in the solid form.

The thermoplastic resin (i), one of the raw materials of continuous-fiber nonwoven fabric contained in the sheet for barrier leg cuffs according to the present invention, may be any existing thermoplastic resin without particular limitation as long as it can be spun into fiber.

Specific examples of applicable thermoplastic resins include the following:

olefin polymers such as homopolymers or copolymers of ethylene, propylene, 1-butene, 1-hexene, 4-methyl-1-pentene, 1-octene, and/or other kinds of α-olefins, for example,

ethylene polymers, such as high-pressure low-density polyethylene (LDPE), linear low-density polyethylene (so-called LLDPE), and high-density polyethylene (HDPE);

propylene polymers, such as polypropylene (propylene homopolymer) and propylene/α-olefin random copolymers (examples of applicable α-olefins include ethylene, 1-butene, 1-hexene, 4-methyl-1-pentene, 1-octene, and so forth);

poly(1-butene), poly(4-methyl-1-pentene), ethylene/propylene random copolymers, ethylene/1-butene random copolymers, and propylene/1-butene random copolymers;

polyesters, such as polyethylene terephthalate, polybutylene terephthalate, and polyethylene naphthalate;

polyamides, such as nylon 6, nylon 66, and polymethaxylene adipamide;

polyvinyl chloride; polyimides; ethylene/vinyl acetate copolymers; polyacrylonitrile; polycarbonates; polystyrene; ionomers; mixtures of them; and so forth.

Among these resins, the olefin polymers, such as ethylene polymers and propylene polymers, are preferable because of their excellent water repellency; the propylene/α-olefin random copolymers are particularly preferable because of their higher water repellency than that of the others.

The molecular weight of the thermoplastic resin (i) is not particularly limited as long as it allows the thermoplastic resin to be melted and spun into fiber.

In addition, when any one of the above-described propylene/α-olefin random copolymers is used, no particular limitations are imposed as long as the copolymer can be spun into fiber; however, usually, the content of α-olefin in the propylene/α-olefin random copolymer is in the range of 1 to 10 mol %.

When a propylene polymer or an ethylene polymer is used in the present invention as the thermoplastic resin (i), the melt-flow rate (MFR) of the resin (B) is not particularly limited as long as it allows the thermoplastic resin (i) to be spun into fiber; however, it is usually in the range of 20 to 100 g/10 minutes, preferably, 40 to 80 g/10 minutes.

In addition, for the resin (B) being a propylene polymer, the above-described MFR is measured under its corresponding conditions in ASTM D 1238, namely, at 230° C. and with a load of 2.16 kg; for the resin (B) being a polyethylene polymer, the above-described MFR is measured under its corresponding conditions in ASTM D 1238, namely, at 190° C. and with a load of 2.16 kg.

If necessary, the thermoplastic resin (i) used in the present invention may contain commonly used additives or other kinds of polymers unless this prevents the achievement of the object of the present invention.

Examples of applicable additives include antioxidants, weathering stabilizers, antistatic agents, antifog agents, antiblocking agents, lubricants, nucleating agents, pigments, and so forth.

<Thermoplastic Elastomer (ii)>

The thermoplastic elastomer (ii), one of the raw materials of continuous-fiber nonwoven fabric contained in the sheet for barrier leg cuffs according to the present invention, may be any existing thermoplastic elastomer as long as it can be spun into fiber. The thermoplastic elastomer may be used alone or in combination of two or more kinds thereof.

Specific examples of applicable thermoplastic elastomers include the following:

styrene elastomers, which are block copolymers containing a polymer block containing at least one aromatic vinyl compound, such as styrene, and another polymer block containing at least one conjugated diene compound, such as butadiene or isoprene, and hydrogenated products thereof, and are represented by polystyrene/polybutadiene/polystyrene block copolymers (referred to as SBS), polystyrene/polyisoprene/polystyrene block copolymers (referred to as SIS), and hydrogenated products thereof, polystyrene/polyethylene-butylene/polystyrene block copolymers (referred to as SEGS) and polystyrene/polyethylene-propylene/polystyrene block copolymers (referred to as SEPS);

polyester elastomers represented by block copolymers containing a highly crystalline aromatic polyester and an amorphous aliphatic polyether;

polyamide elastomers represented by block copolymers containing a crystalline polyamide with a higher melting-point point and an amorphous polyether or polyester with a low glass transition temperature (Tg);

thermoplastic polyurethane elastomers represented by block copolymers whose hard segment contains polyurethane and whose soft segment contains a polycarbonate polyol, an ether polyol, a caprolactone polyester, an adipate polyester, or the like;

amorphous or low crystalline random copolymers solely containing an amorphous or low crystalline ethylene/α-olefin random copolymer, propylene/α-olefin random copolymer, propylene/ethylene/α-olefin random copolymer, or the like as well as polyolefin elastomers obtained by mixing any one of the above-described amorphous or low crystalline random copolymers with a propylene homopolymer, a copolymer of propylene and a small amount of an α-olefin, high-density polyethylene, medium-density polyethylene, or some other crystalline polyolefin;

vinyl chloride elastomers;

fluoroelastomers; and so forth.

Mixed-continuous-fiber nonwoven fabric containing any of these thermoplastic polyurethane elastomers is superior in extensibility, workability, and other aspects to that containing any other kind of thermoplastic elastomer and thus is preferable.

In addition, preferred ones of the polyolefin elastomers are those containing a polypropylene resin composition that contains isotactic polypropylene from 1 to 40 weight % and an amorphous or low crystalline propylene/ethylene/α-olefin copolymer from 60 to 99 parts by weight.

The molecular weight (ii) of the thermoplastic elastomer is not particularly limited as long as it allows the thermoplastic elastomer to be melted and spun into fiber.

Additionally, when used in the present invention, the thermoplastic polyurethane elastomer preferably has a melt viscosity in the range of 100 to 3000 Pa·s, more preferably, 200 to 2000 Pa·s, under the conditions with a temperature of 200° C. and a shear velocity of 100 sec⁻¹. The melt viscosity mentioned here is a measurement obtained using a capilograph (manufactured by Toyo Seiki, Ltd.; nozzle length: 30 mm; nozzle diameter: 1 mm).

If necessary, the thermoplastic elastomer (ii) used in the present invention may contain commonly used additives or other kinds of polymers unless this prevents the achievement of the object of the present invention.

Examples of applicable additives include antioxidants, weathering stabilizers, antistatic agents, antifog agents, antiblocking agents, lubricants, nucleating agents, pigments, and so forth.

<Continuous-Fiber Nonwoven Fabric (A)>

The continuous-fiber nonwoven fabric (A), which is a form of continuous-fiber nonwoven fabric contained in the sheet for barrier leg cuffs according to the present invention, is a bulky continuous-fiber nonwoven fabric and usually includes crimped fiber.

The crimped fiber contained in the continuous-fiber nonwoven fabric (A) used in the present invention is a fiber having crimped filaments. The number of crimps is usually at least 10 crimps/25 mm, preferably at least 15 crimps/25 mm, and more preferably at least 20 crimps/25 mm.

Examples of the crimped fiber used in the present invention include the following:

crimped fiber, fiber with a modified cross-section, and eccentric hollow fiber obtained by crimping fiber containing a single kind of polymer chosen from the thermoplastic resin (i), thermoplastic elastomer (ii), and the other raw materials of the above-described continuous-fiber nonwoven fabric by any existing method, for example, by applying a mechanical stress to the fiber;

crimped fiber whose crimps are due to strain caused during cooling of the fiber, for example, eccentric core-in-sheath conjugated fiber, parallel (side-by-side) conjugated fiber, hollow conjugated fiber, eccentric hollow conjugated fiber, and other similar kinds of conjugated fiber obtained by combining several kinds of thermoplastic resins (i), thermoplastic elastomers (ii), or the like that are different in terms of crystallization temperature, melting point or softening point, crystallization speed, melt viscosity, and other characteristics; and so forth.

[Conjugated Fiber as a Component of Crimped Fiber]

When contained in the crimped fiber used in the present invention, the above-described conjugated fiber contains two or more kinds of thermoplastic resins and, usually, can take the fiber structure of eccentric core-in-sheath conjugated fiber or parallel conjugated fiber. The conjugated fiber can be crimped by any existing method. Examples of applicable methods include a method in which the conjugated fiber is crimped by drawing and heat treatment, a method that needs no drawing process to crimp the conjugated fiber, for example, a method in which the conjugated fiber is heated at a temperature 5 to 30° C. lower than the melting point of the lower melting-point component thereof, a method in which the conjugated fiber is crimped by melt spinning followed by cooling, and so forth.

Examples of conjugated fibers preferred in the present invention, namely, conjugated fibers containing two or more kinds of thermoplastic resins with different melting points, include conjugated fibers containing a polyester such as polyethylene terephthalate and a propylene polymer, conjugated fibers containing a polyester such as polyethylene terephthalate and an ethylene polymer, conjugated fibers containing a propylene polymer and an ethylene polymer, and conjugated fibers containing propylene polymers with different melting points, in which no drawing process is needed to crimp these conjugated fibers.

The above-mentioned conjugated fibers, which are composed of two or more kinds of thermoplastic resins with different melting points, can be crimped without drawing. For example, they can be crimped by heating at a temperature 5 to 30° C. lower than the melting point of the lower melting-point component thereof or by melt spinning followed by cooling.

Preferred one of these conjugated fibers is eccentric core-in-sheath or parallel conjugated fiber that contains a propylene polymer with a melting point (Tm) of 155° C. or higher as the first component and a propylene/α-olefin copolymer or an ethylene polymer with a melting point (Tm) of 150° C. or lower as the second component at a ratio (weight ratio) of the first component to the second component in the range of 5/95 to 95/5, preferably, 5/95 to 30/70.

### Eccentric Core-In-Sheath Conjugated Fiber

Any kind of eccentric core-in-sheath conjugated fiber can be used in the present invention with no particular limitations unless in its structure the axis (center) of the core, the above-described polypropylene polymer, coincides with the axis (center) of the conjugated fiber. In particular, eccentric core-in-sheath conjugated fiber in which the axis of the core, the above-described propylene polymer, is more distant from the axis of the conjugated fiber can be crimped more easily than that in which the axis of the core, the above-described propylene polymer, is less distant from the axis of the conjugated fiber and thus is preferable. Note that the core, the above-described propylene polymer, may be exposed in part on the surface of the eccentric core-in-sheath conjugated fiber.

Parallel Conjugated Fiber

In parallel conjugated fiber used in the present invention, the boundaries between the components thereof, for example, the above-described propylene polymer as the first component and the above-described propylene/α-olefin copolymer as the second component, on a fiber section (a cross-section obtained by cutting the fiber perpendicular to the longitudinal axis is simply referred to as the “fiber section”; this applies throughout the whole present description) may be lines or arcs. When the boundaries on a fiber section are arcs, these boundaries may form an approximately circular shape, in which the propylene polymer intrudes in the propylene/a-olefin copolymer part, or a crescent shape, in which the propylene polymer is concave.

Hollow Conjugated Fiber and Eccentric Hollow Conjugated Fiber

The hollow conjugated fiber used in the present invention is a hollow conjugated fiber obtained as the above-described parallel conjugated fiber with a hollow formed in the inside thereof. In particular, eccentric hollow conjugated fiber, in which the hollow thereof is eccentric, is excellent in terms of crimpiness, thereby giving continuous-fiber nonwoven fabric excellent in terms of bulkiness, and thus is preferable.

In particular, when the above-described propylene polymer for forming the first component and the above-described propylene/α-olefin copolymer for forming the second component are used, preferable eccentric hollow conjugated fiber is a eccentric hollow conjugated fiber in which the ratio (weight ratio) of the first component to the second component is in the range of 5/95 to 95/5, more preferably, 5/95 to 30/70, and the hollow is eccentric to the above-described propylene polymer being the second component, and thus the thickness of the second component part is smaller than that of the first component part, from the viewpoint of its excellent crimpiness.

<Continuous-Fiber Nonwoven Fabric (B)>

The continuous-fiber nonwoven fabric (B), which is a form of continuous-fiber nonwoven fabric contained in the sheet for barrier leg cuffs according to the present invention, is a bulky continuous-fiber nonwoven fabric and usually includes a fiber mixture of a thermoplastic elastomer continuous fiber and an extensible continuous fiber.

[Fiber Mixture]

The fiber mixture for the continuous-fiber nonwoven fabric (B) used in the present invention is a fiber mixture obtained by mixing an extensible fiber and a thermoplastic elastomer fiber; preferably, it is a fiber mixture obtained by mixing an extensible fiber of 10 to 90 mass %, preferably 20 to 70 mass and a thermoplastic elastomer of 90 to 10 mass %, preferably 80 to 30 mass %.

The extensible fiber mentioned here is a fiber that can be used to make continuous-fiber nonwoven fabric by a method for manufacturing spunbonded nonwoven fabric with the elongation at maximum stress being at least 50%, preferably, 70% or higher, more preferably, 100% or higher, and that is produced from a resin containing a thermoplastic resin with little elastic recovery as a main component (usually, 10 to 100%).

On the other hand, the thermoplastic elastomer fiber is a fiber that is produced from an elastomer containing the above-described thermoplastic elastomer (ii) as a main component (usually, 10 to 100%).

The continuous-fiber nonwoven fabric (B) used in the present invention, which includes a fiber mixture, can be made bulkier by drawing in one or more directions followed by stress relaxation for elastic recovery of the thermoplastic elastomer fiber.

More specifically, the continuous-fiber nonwoven fabric (B) used in the present invention, which includes a fiber mixture, can be made bulkier in the following way.

For example, some filaments of the fiber mixture are subjected to confounding treatment or are thermally bonded together by needle punching, water jet treatment, ultrasonication, hot embossing, or some other applicable method. Then, the fiber mixture obtained is drawn in one or more directions using rollers, a tentering machine, or gears; the degree of drawing is preferably 50% or higher, more preferably, 100% or higher, but preferably 1000% or lower, more preferably, 400% or lower. Then, the stress is relaxed. In this way, the thermoplastic elastomer fiber contained in the fiber mixture undergoes elastic recovery, while the extensible continuous fiber extended in the fiber mixture is folded, yielding bulky continuous-fiber nonwoven fabric.

Extensible Continuous Fiber

The extensible continuous fiber, one of the fibers contained in the fiber mixture composing the continuous-fiber nonwoven fabric (B) used in the present invention, is a thermoplastic resin chosen from the above-listed thermoplastic resins (i); it allows thermoplastic resin fiber, which contains a thermoplastic resin as a main component, made therefrom to be used to make continuous-fiber nonwoven fabric by spunbonding with the elongation at maximum stress being at least 50%, preferably, 70% or higher, more preferably, 100% or higher, and has less elastic recovery (an extensible thermoplastic resin). The elongation at maximum stress mentioned here represents the elongation of the continuous-fiber nonwoven fabric in the machine direction (MD) and/or the cross direction (CD).

In addition, the elongation at maximum stress of spunbonded nonwoven fabric containing a thermoplastic resin (i) has no particular upper limit; however, it is usually 300% or lower.

From the viewpoint of spinning stability during molding and the drawability of resultant nonwoven fabric, preferred ones of the above-listed thermoplastic resins (i) are polyolefins, and particularly preferred ones are propylene polymers.

The continuous-fiber nonwoven fabric (B), which is obtained by mixing the continuous fiber of such an extensible resin and that of a thermoplastic elastomer (ii), is not only able to be made bulkier by drawing for improved feel but also provides laminates made therefrom with the function of limiting elongation and thus is preferable.

Preferred examples of the above-mentioned propylene polymers are propylene homopolymers whose melting point (Tm) is at least 155° C., preferably, in the range of 157 to 165° C., and ethylene/α-olefin copolymers that are copolymers of propylene and a minimum amount of one or more kinds of α-olefins of two or more carbon atoms (excluding those of three carbon atoms), preferably, two to eight carbon atoms (excluding those of three carbon atoms), such as ethylene, 1-butene, 1-pentene, 1-hexene, 1-octene, and 4-methyl-1-pentene.

The melt-flow rate (MFR according to ASTM D-1238 measured at 230° C. with a load of 2160 g) of the propylene polymer used is not particularly limited as long as it allows the propylene polymer to be melted and spun into fiber; however, it is usually in the range of 1 to 1000 g/10 minutes, preferably, 5 to 500 g/10 minutes, more preferably, 10 to 100 g/10 minutes. Also, the ratio of the weight average molecular weight (Mw) to the number average molecular weight (Mn) of the propylene polymer used in the present invention, Mw/Mn, is usually in the range of 1.5 to 5.0. Preferably, this ratio Mw/Mn of the propylene polymer is in the range of 1.5 to 3.0 from the viewpoint that this provides the resultant fiber with favorable spinnability and extremely high fiber strength. Mw and Mn can be measured by existing methods based on GPC (gel permeation chromatography).

Olefin polymer compositions obtained by adding a small amount of high-density polyethylene (HDPE) to propylene polymer further improve the suitability of resultant nonwoven fabric laminates to be drawn and thus are preferable.

From the viewpoint of spinnability and drawability, the content of the above-mentioned HDPE is preferably in the range of 1 to 20 weight %, more preferably, 2 to 15 weight %, even more preferably, 4 to 10 weight %, provided that the total of propylene polymer and HDPE is 100 weight %.

The density of the HDPE added to the propylene polymer is not particularly limited; however, it is usually in the range of 0.94 to 0.97 g/cm³, preferably, 0.95 to 0.97 g/cm³, more preferably, 0.96 to 0.97 g/cm³. Also, the melt-flow rate (MFR according to ASTM D-1238 measured at 190° C. with a load of 2160 g) of the HDPE is not particularly limited as long as it allows the HDPE to be spun; however, from the viewpoint of extensibility, it is usually in the range of 0.1 to 100 g/10 minutes, more preferably, 0.5 to 50 g/10 minutes, further more preferably, 1 to 30 g/10 minutes. Note that in the present invention, the spinnability is considered favorable when the resin can be discharged from a spinning nozzle and drawn with no filaments broken or fused.

A preferred example of the continuous-fiber nonwoven fabric (B) used in the present invention is a fiber mixture of a thermoplastic elastomer continuous fiber containing a thermoplastic polyurethane elastomer or a thermoplastic polyolefin elastomer and an extensible continuous fiber (a thermoplastic resin continuous fiber) containing a propylene polymer, and a particularly preferred example of the continuous-fiber nonwoven fabric (B) used in the present invention is a fiber mixture of a thermoplastic elastomer continuous fiber containing a thermoplastic polyurethane elastomer and an extensible continuous fiber (a thermoplastic resin continuous fiber) containing a propylene polymer containing HDPE.

Continuous-fiber nonwoven fabric (B) including any one of fiber mixtures according to the above-listed combinations is superior in spinnability and drawability to others, and continuous-fiber nonwoven fabric made from such a fiber mixture is superior in bulkiness to others.

In the continuous-fiber nonwoven fabric used in the present invention (continuous-fiber nonwoven fabrics (A) and (B)), confounding of some filaments may be performed in advance by any one of various existing methods, if necessary. Examples of applicable confounding methods include those based on needle punching, water jet treatment, ultrasonication, or the like, hot embossing using an embossing roller, methods in which hot air is used to fuse some filaments, and so forth. These confounding methods may be used alone or in combination of two or more kinds thereof.

When thermal fusion bonding based on hot embossing is employed, the percentage of embossed area is usually in the range of 5 to 25%, preferably, 10 to 25%, and the unit area of unembossed regions is usually at least 0.5 mm², preferably, in the range of 6 to 40 mm². In the present invention, the unembossed regions represent regions each surrounded on all four sides by embossed regions, and the unit area of unembossed regions is defined as the area of the largest inscribed square in the smallest unembossed region. With the percentage of embossed area and the unit area of unembossed regions falling within the above-specified ranges, resultant embossed continuous-fiber nonwoven fabric is excellent in terms of bulkiness, has high air permeability, and offers excellent performance in preventing the leakage of loose feces.

<Sheet for Barrier Leg Cuffs>

The sheet for barrier leg cuffs according to the present invention contains a continuous-fiber nonwoven fabric in which the ratio of the thickness to the basis weight is at least 0.015 mm/(g/m²), preferably, in the range of 0.015 to 0.030 mm/(g/m²).

Preferably, in the sheet for barrier leg cuffs according to the present invention, the continuous-fiber nonwoven fabric has a basis weight of 5 g/m² or greater, preferably, g/m², more preferably, 10 to 25 g/m².

More preferably, in the sheet for barrier leg cuffs according to the present invention, the continuous-fiber nonwoven fabric has a degree of air permeability of 300 cc/cm²/second or higher, preferably, in the range of 300 to 500 cc/cm²/second.

Sheets containing a continuous-fiber nonwoven fabric whose basis weight is less than 5 g/m² and whose degree of air permeability is less than 300 cc/cm²/second and those containing a continuous-fiber nonwoven fabric in which the ratio of the thickness to the basis weight is lower than 0.015 mm/(g/m²) possibly offer insufficient performance in preventing the leakage of urine and loose feces when used in barrier leg cuffs of disposable diapers. Also, sheets containing a continuous-fiber nonwoven fabric whose degree of air permeability is less than 300 cc/cm²/second tend to retain too much moisture therein. On the other hand, sheets containing a continuous-fiber nonwoven fabric whose basis weight is greater than 30 g/m² and those containing a continuous-fiber nonwoven fabric in which the ratio of the thickness to the basis weight is higher than 0.030 mm/(g/m²) are possibly too bulky and inferior in air permeability.

The sheet for barrier leg cuffs containing a continuous-fiber nonwoven fabric having the ratio of the thickness to the basis weight of 0.015 mm/(g/m²) or higher according to the present invention is a continuous-fiber nonwoven fabric bulkier than ordinary continuous-fiber nonwoven fabric and nonwoven fabric laminates consisting of continuous-fiber nonwoven fabric and melt-blown nonwoven fabric.

When the above-described continuous-fiber nonwoven fabric is used in barrier leg cuffs of disposable diapers, the degree of water resistance thereof may be 50 mmH₂O or higher from the viewpoint of preventing the leakage of urine, as described in the prior patent filed under PCT International Patent Application Publication No. WO01/53585. For more reliable prevention of leakage, however, the degree of water resistance is usually at least 60 mmH₂O, preferably, 70 mmH₂O or higher.

For the prevention of too much moisture retention around skin, however, the degree of water resistance of the above-described continuous-fiber nonwoven fabric is usually not more than 300 mmH₂O, preferably, 250 mmH₂O or lower, more preferably, 200 mmH₂O or lower.

The degree of water resistance of continuous-fiber nonwoven fabric can be controlled by narrowing the fiber diameter.

It should be noted that the sheet for barrier leg cuffs according to the present invention, which contains the above-described continuous-fiber nonwoven fabric, may have an additional layer of melt-blown nonwoven fabric with a basis weight in the range of 0.5 to 5 g/m² to either side of the continuous-fiber nonwoven fabric, yielding a laminate. With the layer of melt-blown nonwoven fabric laminated, the sheet for barrier leg cuffs becomes slightly less air impermeable but acquires further improved performance in preventing the leakage of urine or loose feces instead. Examples of possible compositions of the laminate include continuous-fiber nonwoven fabric/melt-blown nonwoven fabric, continuous-fiber nonwoven fabric/melt-blown nonwoven fabric/continuous-fiber nonwoven fabric, and the composition containing the composition as described above. In addition, it is desirable for feel against skin and air permeability that the continuous-fiber nonwoven fabric side of the sheet for barrier leg cuffs comes in contact with skin.

<Method for Manufacturing the Continuous-Fiber Nonwoven Fabric>

The continuous-fiber nonwoven fabric used in the present invention can be manufactured by various existing methods for manufacturing of nonwoven fabric; however, it is preferably produced by spunbonding.

For example, the continuous-fiber nonwoven fabric (A), which contains crimped fiber, can be made from one or more kinds of thermoplastic resins or thermoplastic elastomers using an apparatus for manufacturing spunbonded nonwoven fabric equipped with a die having a nozzle for forming conjugated fiber.

Examples of the above-mentioned nozzle for forming conjugated fiber include nozzles for forming fiber with a modified cross-section and those for forming eccentric hollow fiber as well as eccentric core-in-sheath conjugated fiber, parallel (side-by-side) conjugated fiber, hollow conjugated fiber, eccentric hollow conjugated fiber, and so forth.

Also, the continuous-fiber nonwoven fabric (B), which contains a fiber mixture, can be made from an extensible continuous fiber and a thermoplastic elastomer (ii) using an apparatus for manufacturing spunbonded nonwoven fabric equipped with a die having a spinning nozzle for thermoplastic resin and that for thermoplastic elastomer.

To acquire bulkiness, the above-described continuous-fiber nonwoven fabric, which contains a fiber mixture, is subjected to post-production treatment including drawing in one or more directions and subsequent relaxation for the folding of the extensible fiber.

<Manufacturing Method and Usage of the Sheet for Barrier Leg Cuffs>

The sheet for barrier leg cuffs according to the present invention can be manufactured by various existing methods from continuous-fiber nonwoven fabric produced in the above-described way.

Diapers are usually put on users (e.g., infants, the elderly, or patients) in such a manner that loose feces are prevented from leaking through the leg holes; thus, when the sheet for barrier leg cuffs according to the present invention is used in disposable diapers, rubber strings or something similar is applied to the sheet if higher extensibility is needed, and then the sheet is attached to the edge of each of the left and right leg holes.

### EXAMPLES

Hereinafter, the present invention is described in more detail with reference to examples thereof; however, the present invention is never limited to these examples.

Note that the physical properties and others of Examples and Comparative Examples were measured as follows.

(I) Physical Properties and Others of Continuous-Fiber Nonwoven Fabric

(1) Basis Weight (g/m²)

The basis weight was measured in accordance with the measuring method specified in 5.2 of JIS L 1906.

(2) Degree of Air Permeability (cc/cm²/second)

The degree of air permeability was measured in accordance with Method A (Franzier's test method) specified in 1 of JIS L 1906.

(3) Thickness/Basis Weight [mm/(g/m²)]

The ratio of thickness to basis weight was determined by measuring the thickness of continuous-fiber nonwoven fabric (sheets for barrier leg cuffs) in accordance with JIS L 1906 and then dividing the thickness obtained by the above-described basis weight.

(4) Number of Crimps (per 25 mm)

The number of crimps was determined as follows.

Prior to the test, slips of smooth and glossy paper were each given lines with a spatial distance of 25 mm. Then, with continuous-fiber nonwoven fabric that had not been heated or pressurized using an embossing roller as the source, filaments of the eccentric hollow conjugated fiber were sampled carefully so that the crampiness would be maintained. Then, the sampled filaments of the eccentric hollow conjugated fiber were individually bonded at both ends to the above-described slips of paper using an adhesive with the laxity measuring 25±5% of the spatial distance. Then, the number of crimps was determined for the specimens obtained, individual filaments of the eccentric hollow conjugated fiber, in the following way. One of the filaments of the eccentric hollow fiber was held with the chucks of a crimp tester, the slip of paper was cut, and then the initial load (0.18 mN×the line density indicated in tex) was applied to the specimen. Then, the distance between the chucks (spatial distance) (mm) was recorded, the crimps were counted, and the number of crimps per 25 mm length was calculated. Note that the number of crimps counted was the value obtained by counting all peaks and bottoms and then dividing the total number by two.

The number of crimps was determined for twenty filaments of the eccentric hollow conjugated fiber in the way described above, and then the average number of crimps determined was rounded off to one decimal place; the value obtained was defined as the number of crimps of the eccentric hollow conjugated fiber. Note that this test for the number of crimps was carried out under the conditions specified in JIS 28703 (Standard atmospheric conditions for testing), or in an air-conditioned room with the temperature set at 20±2° C. and the humidity set at 65±2%.

(5) Amount of Loose Feces Effusion

The amount of loose feces effusion was measured as follows.

Artificial loose feces with a viscosity of 300 cps were prepared by dispersing bentonite and mayonnaise in water at content ratios of 8.0 weight % and 4.8 weight %, respectively, and then mixing the ingredients to uniformity. Then, 5 g of the above-described artificial loose feces was placed on a polyethylene film, and then a sheet of continuous-fiber nonwoven fabric (the sheet for barrier leg cuffs) and a piece of standard filter paper (“ADVANTEC” No. 63 manufactured by Toyo Roshi Kaisha, Ltd.) that measured 10×10 cm and had been weighed were placed thereon. Then, a weight having a footprint of 10×10 cm and weighing 3.5 kg, an estimated body weight of a baby, was placed on the piece of filter paper and then allowed to stand for 2 minutes. After that, the piece of filter paper was weighed; the weight obtained was used to calculate the amount of effusion (g) of the artificial loose feces.

When the amount of effusion of the artificial loose feces was less than 3 g, the specimen was judged to be “effective in preventing effusion (0)”; when the amount of effusion was equal to or more than 3 g, the specimen was judged to be “ineffective in preventing effusion (x).” Note that the test for the number of crimps was carried out under the conditions specified in JIS 28703 (Standard atmospheric conditions for testing), or in an air-conditioned room with the temperature set at 20±2° C. and the humidity set at 65±2%.

(6) Degree of Water Resistance [mmH₂O]

The degree of water resistance was measured in accordance with JIS L1092. Six specimens each measuring 200 mm (MD)×50 mm (CD) were sampled from a sheet of nonwoven fabric and/or a nonwoven fabric laminate. The number of sampling point was three each for MD and CD (six points in total). Then, the specimens sampled were individually attached to a water-resistance tester (for low water pressures; product number: FI-805; manufactured by Tester Sangyo Co., Ltd.) in such a direction that water could press the front surface of the specimens. Then, the level adjuster containing water at room temperature was raised at a rate of 60±30 mm/min. or 10±5 mm/min. in order that water pressure could be applied to the specimens. The water level was measured at the time water leaked over the back surface of each specimen at three points, and then the degree of water resistance [mmH₂O] was calculated. Note that the degree of water resistance was defined as the value obtained by averaging the degree of water resistance for the above-described six points (three points each for MD and CD) and then rounding off the average to the nearest integer.

(II) Physical Properties and Others of Thermoplastic Polyurethane Elastomer

(7) Solidification Starting Temperature

The solidification starting temperature was measured using a differential scanning calorimeter (DSC220C) connected to SSC5200H Disk Station manufactured by Seiko Instruments & Electronics Ltd. Approximately 8 g of ground particles of TPU was collected as a sample on an aluminum pan, covered, and then crimped. Alumina was also collected as a reference in the same way. The sample and reference were placed on the positions indicated in the cell and subjected to measurement under nitrogen flow with a flow rate of 40 Nml/min. The temperature was increased from room temperature to 230° C. at a heating rate of 10° C./min, the sample was held for 5 minutes at the temperature reached, and then the temperature was reduced to −75° C. at a cooling rate of 10° C./min. The starting temperature of the exothermic peak recorded, which was attributable to the solidification of TPU, was measured and defined as the solidification starting temperature (unit: ° C.).

(8) Number of Particles Insoluble in Polar Solvent

The number of particles insoluble in polar solvent was measured using Multiserzer II manufactured by Beckman Coulter, Inc. as a particle size analyzer based on the electrical sensing zone method. In a 5-liter separable flask, 3500 g of dimethylacetamide (manufactured by Wako Pure Chemical Industries, Ltd.; special grade) and 145.83 g of ammonium thiocyanate (manufactured by Junsei Chemical Co., Ltd.; special grade) were weighed. Then, ammonium thiocyanate was dissolved in dimethylacetamide at room temperature for 24 hours.

Then, vacuum filtration was carried out using a 1-μm membrane filter, and the reagent obtained was named Reagent A. In a 200-cc glass bottle, 180 g of Reagent A and 2.37 g of TPU pellets were precisely weighed, and then the soluble fraction of TPU was dissolved in Reagent A for 3 hours, yielding a specimen for measurement. A 100-μm aperture tube was attached to Multisizer II, the solvent existing in the apparatus was replaced with Reagent A, and then the degree of pressure reduction was adjusted to approximately 3000 mmAq. Then, 120 g of Reagent A was weighed in a well-washed beaker for specimen charge-in and measured as the blank; this measurement confirmed that the rate of pulses generated was not greater than 50 pulses/minute. The Current value and Gain were manually set to their respective ideal levels, and then calibration was conducted using 10-μm non-cross-linked polystyrene standard particles. For measurement, 120 g of Reagent A and approximately 10 g of the specimen for measurement were weighed in another well-washed beaker for specimen charge-in, and the solution obtained was subjected to measurement; the measurement duration was set at 210 seconds. The value obtained by dividing the number of particles counted during this measurement phase by the weight of TPU aspirated into the aperture tube was defined as the number of particles of the TPU fraction insoluble in polar solvent (unit: particles/g). Note that the weight of TPU was calculated using the following formula.

Weight of TPU={(A/100)×B/(B+C)}×D

where A: TPU concentration in the specimen for measurement (weight %); B: weight of the specimen for measurement measured in a beaker (g); C: weight of Reagent A measured in a beaker (g); and D: weight of solution aspirated into the aperture tube during the measurement phase (210 seconds) (g).

(9) Proportion of the Hard Domain in Heat of Fusion

The proportion of the hard domain in heat of fusion was measured using a differential scanning calorimeter (DSC220C) connected to SSC5200H Disk Station manufactured by Seiko Instruments & Electronics Ltd. Approximately 8 g of ground particles of TPU was collected as a sample on an aluminum pan, covered, and then crimped. Alumina was also collected as a reference in the same way. The sample and reference were placed on the positions indicated in the cell and subjected to measurement under nitrogen flow with a flow rate of 40 Nml/min. The temperature was increased from room temperature to 230° C. at a heating rate of 10° C./min. The total heat of fusion (a) based on endothermic peaks whose peak temperature was in the range of 90 to 140° C. and the total heat of fusion (b) based on endothermic peaks whose peak temperature was higher than 140° C. but not higher than 220° C. were determined. Then, the proportion of the hard domain in heat of fusion was calculated using the following formula (unit: %).

Proportion of the hard domain in heat of fusion (%)=a/(a+b)×100

(10) Melt viscosity at 200° C. (hereinafter, simply referred to as “the melt viscosity”)

In a capilograph (model 1C manufactured by Toyo Seiki, Ltd.), the melt viscosity of TPU (unit: unit: Pa·s) was measured at 200° C. with a shear velocity of 100 sec⁻¹. The nozzle used had a length of 30 mm and a diameter of 1 mm.

### Example 1

Higher melting-point thermoplastic resin: A propylene homopolymer (MFR measured at 230° C. under a load of 2160 g: 60 g/10 minutes; melting point (Tmo): 157° C.)

Lower melting-point thermoplastic resin: A propylene/ethylene random copolymer (MFR measured at 230° C. under a load of 2160 g: 60 g/10 minutes; Mw/Mn=2.4; melting point (Tmo): 143° C.; ethylene content: 4 mol %)

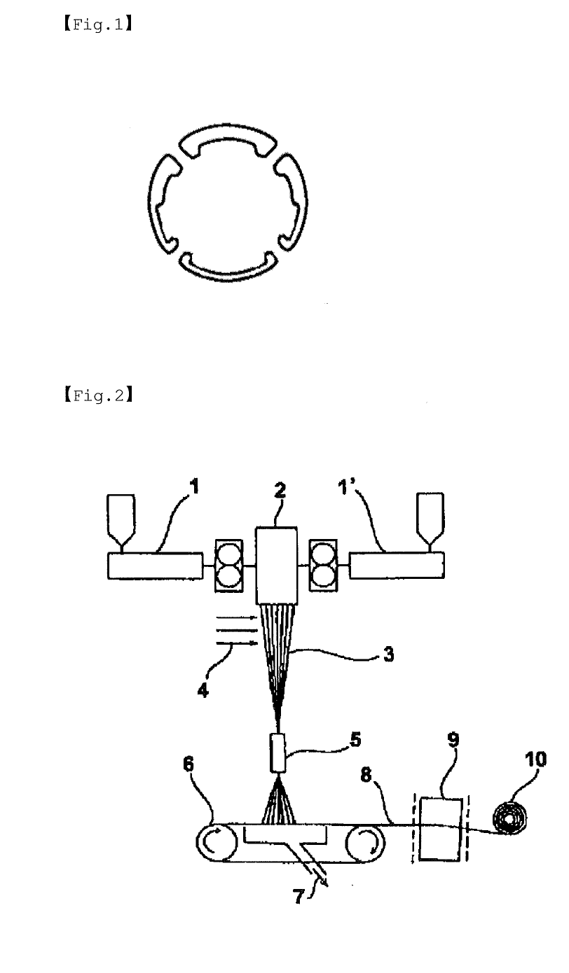

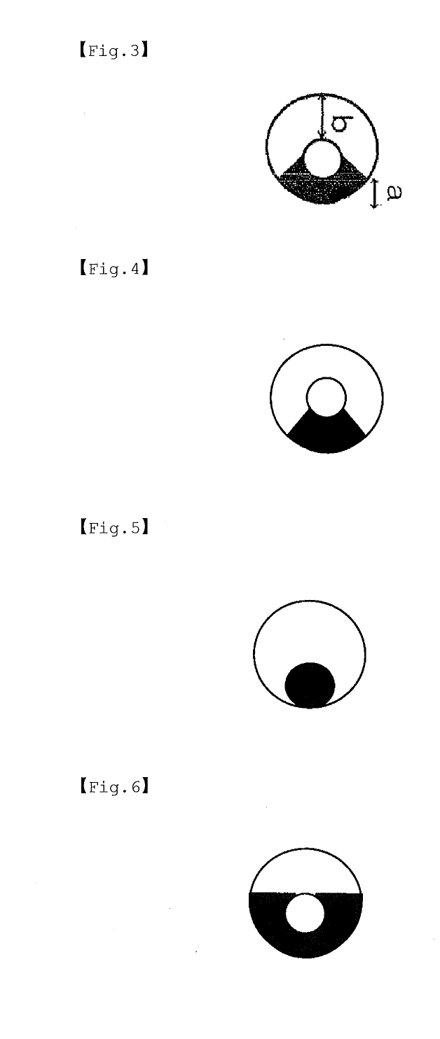

The above-described higher melting-point thermoplastic resin and lower melting-point thermoplastic resin were melted in separate extruders (each having a diameter of 30 mm) with the molding temperature set at 200° C. Then, a sheet for barrier leg cuffs was manufactured from continuous-fiber nonwoven fabric in the apparatus for making nonwoven fabric shown in FIG. 2 (a spunbonding machine; length perpendicular to the machine direction on the collection surface: 100 mm). This apparatus had a spinneret whose nozzle pitch was 9.1 mm in the machine direction and 8.3 mm in the cross direction and whose slit arrangement was as shown in FIG. 1. More specifically, the manufacturing procedure was as follows. The higher melting-point thermoplastic resin and lower melting-point thermoplastic resin were spun into eccentric hollow conjugated continuous fiber that had the cross-sectional shape shown in FIG. 3, with the weight ratio of the higher melting-point thermoplastic resin to the lower melting-point thermoplastic resin set at 20/80. The eccentric hollow conjugated continuous fiber spun was drawn at a yarn speed of 3000 m/minute under cooling with air (25° C.), allowed to accumulate on the collection belt. Then, the deposit obtained was heated and pressurized with a quilt embossing roller (percentage of embossed area: 9.7%; temperature of embossing: 125° C.), yielding a sheet for barrier leg cuffs made from continuous-fiber nonwoven fabric (A) with a basis weight of 25 g/m².

Note that in FIG. 2, the numeral 1 represents the first extruder, and the numeral 1′ the second extruder; the first extruder and the second extruder contain different kinds of resins. In FIG. 1, the numeral 2 represents a spinneret, the numeral 3 serial filaments, the numeral 4 cooling air, the numeral 5 an ejector, the numeral 6 a collector, the numeral 7 an aspirator, the numeral 8 a web, and the numeral 9 a take-up roller.

The characteristics of the sheet for barrier leg cuffs obtained were measured in the ways described earlier. The measurements are shown in Table 1.

### Example 2

Higher melting-point thermoplastic resin: A propylene homopolymer (MFR measured at 230° C. under a load of 2160 g: 60 g/10 minutes; melting point (Tmo): 157° C.)

Lower melting-point thermoplastic resin: A propylene/ethylene random copolymer (MFR measured at 230° C. under a load of 2160 g: 60 g/10 minutes; Mw/Mn=2.4; melting point (Tmo): 143° C.; ethylene content: 4 mol %)

The above-described higher melting-point thermoplastic resin and lower melting-point thermoplastic resin were melted in separate extruders (each having a diameter of 30 mm) with the molding temperature set at 200° C. Then, a sheet for barrier leg cuffs was manufactured from continuous-fiber nonwoven fabric in the apparatus for making nonwoven fabric shown in FIG. 2 (a spunbonding machine; length perpendicular to the machine direction on the collection surface: 100 mm). This apparatus had a spinneret whose nozzle pitch was 9.1 mm in the machine direction and 8.3 mm in the cross direction, and the spinneret was positioned so that the fiber section shown in FIG. 4 could be obtained. More specifically, the manufacturing procedure was as follows. The higher melting-point thermoplastic resin and lower melting-point thermoplastic resin were spun into crimped conjugated continuous fiber with the weight ratio of the higher melting-point thermoplastic resin to the lower melting-point thermoplastic resin set at 20/80. The crimped conjugated continuous fiber spun was drawn at a yarn speed of 2500 m/minute under cooling with air (25° C.), allowed to accumulate on the collection belt. Then, the deposit obtained was heated and pressurized with a quilt embossing roller (percentage of embossed area: 9.7%; temperature of embossing: 125° C.), yielding a sheet for barrier leg cuffs made from continuous-fiber nonwoven fabric (A) with a basis weight of 25 g/m².

The characteristics of the sheet for barrier leg cuffs obtained were measured in the ways described earlier. The measurements are shown in Table 1.

### Example 3

Higher melting-point thermoplastic resin: A propylene homopolymer (MFR measured at 230° C. under a load of 2160 g: 60 g/10 minutes; melting point (Tmo): 157° C.)

Lower melting-point thermoplastic resin: A propylene/ethylene random copolymer (MFR measured at 230° C. under a load of 2160 g: 60 g/10 minutes; Mw/Mn=2.4; melting point (Tmo): 143° C.; ethylene content: 4 mol %)

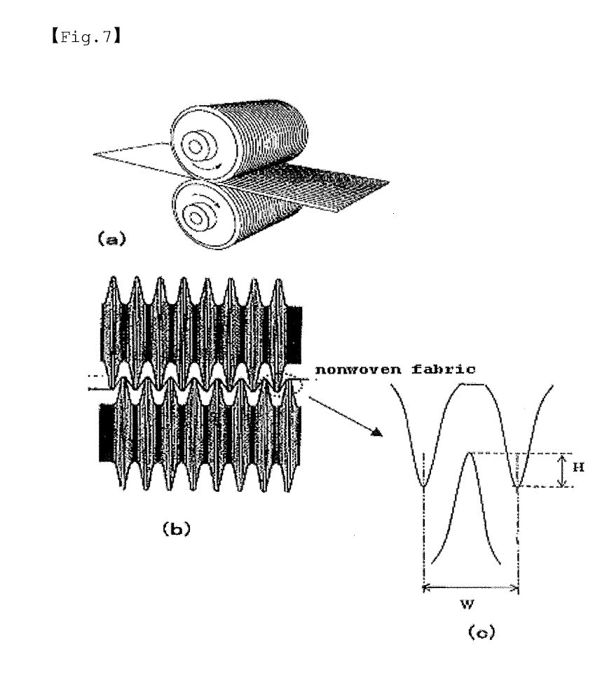

The above-described higher melting-point thermoplastic resin and lower melting-point thermoplastic resin were melted in separate extruders (each having a diameter of 30 mm) with the molding temperature set at 200° C. Then, a sheet for barrier leg cuffs was manufactured from continuous-fiber nonwoven fabric in the apparatus for making nonwoven fabric shown in FIG. 2 (a spunbonding machine; length perpendicular to the machine direction on the collection surface: 100 mm). This apparatus had a spinneret whose nozzle diameter was 0.6 mm and whose nozzle pitch was 9.1 mm in the machine direction and 8.3 mm in the cross direction, and the spinneret was positioned so that the fiber section shown in FIG. 5 could be obtained. More specifically, the manufacturing procedure was as follows. The higher melting-point thermoplastic resin and lower melting-point thermoplastic resin were spun into crimped conjugated continuous fiber through a spinneret for crimped conjugated fiber that gives the cross-sectional shape shown in FIG. 5, with the weight ratio of the higher melting-point thermoplastic resin to the lower melting-point thermoplastic resin set at 20/80. The crimped conjugated continuous fiber spun was drawn at a yarn speed of 2500 m/minute under cooling with air (25° C.), allowed to accumulate on the collection belt. Then, the deposit obtained was heated and pressurized with a quilt embossing roller (percentage of embossed area: 9.7%; temperature of embossing: 125° C.), yielding a sheet for barrier leg cuffs made from continuous-fiber nonwoven fabric (A) with a basis weight of 25 g/m².

The characteristics of the sheet for barrier leg cuffs obtained were measured in the ways described earlier. The measurements are shown in Table 1.

### Example 4

### Manufacturing of a Thermoplastic Polyurethane Elastomer

Diphenylmethane diisocyanate (hereinafter, referred to as MDI) was put into a tank named Tank A under nitrogen atmosphere, and then the internal temperature of Tank A was adjusted to 45° C. while MDI was being stirred gently enough to avoid the generation of bubbles.

Then a tank named Tank B was charged with 628.6 parts by weight of a polyester polyol having a number average molecular weight of 2000 (manufactured by Mitsui Takeda Chemicals, Inc.; trade name: Takelac U2024), 2.21 parts by weight of Irganox 1010, and 77.5 parts by weight of 1,4-butanediol under nitrogen atmosphere, and then the internal temperature of Tank B was adjusted to 95° C. while the content was being stirred. The mixture obtained is hereinafter referred to as “Polyol Solution 1.”

The proportion of the hard segment calculated from these reactants was 37.1 weight %. Then, MDI and Polyol Solution 1 were allowed to pass through lines each equipped with a gear pump and a flowmeter at flow rates of 17.6 kg/h and 42.4 kg/h, respectively, to reach a high-speed agitator (SM40) preheated to 120° C. In SM40, MDI and Polyol Solution 1 were mixed by stirring at 2000 rpm for 2 minutes and then allowed to proceed to static mixers.

Note that the static mixer unit used had a static mixer series comprising three static mixers each having a tube length of 0.5 m and an inner diameter of 20 mm (static mixers 1 to 3; temperature: 230° C.), three static mixers each having a tube length of 0.5 m and an inner diameter of 20 mm (static mixers 4 to 6; temperature: 220° C.), six static mixers each having a tube length of 1.0 m and an inner diameter of 34 mm (static mixers 7 to 12; temperature: 210° C.), and three static mixers each having a tube length of 0.5 m and an inner diameter of 38 mm (static mixers 13 to 15; temperature: 200° C.).

The reaction product flowing out of the static mixer 15 was pumped with a gear pump into a single-screw extruder (diameter: 65 mm; temperature: 180 to 210° C.) having a polymer filter (manufactured by Nagase Co., Ltd.; trade name: Denafilter) at the end and then extruded from a strand die. The extrusion obtained was cooled with water and then continuously pelletized using a pelletizer. Then, the pellets obtained were put into a drying oven and dried at 100° C. for 8 hours, yielding a thermoplastic polyurethane elastomer with a moisture content of 40 ppm. This thermoplastic polyurethane elastomer was continuously extruded from a single-screw extruder (diameter: 50 mm; temperature: 180 to 210° C.) and then pelletized. The pellets obtained were dried once again at 100° C. for 7 hours, yielding a thermoplastic polyurethane elastomer (TPU-1) with a moisture content of 57 ppm.

The characteristics of TPU-1 were as follows: solidification starting temperature: 103.7° C.; the number of particles insoluble in polar solvent: 1500000 particles/g; hardness of a specimen prepared by injection molding: 86A; melt viscosity at 200° C.: 1900 Pa·s; proportion of the hard domain in heat of fusion: 35.2%. The measurement procedures were as follows.

<Preparation of a Thermoplastic Resin Composition for Spunbonded Nonwoven Fabric>

A thermoplastic resin composition (B-1), a raw material of extensible fiber, was prepared by mixing 96 parts by weight of a propylene homopolymer (hereinafter, abbreviated to “PP-1”) showing an MFR of 60 g/10 minutes (measured in accordance with ASTM D 1238, namely, at 230° C. and with a load of 2.16 kg), a density of 0.91 g/cm³, and a melting point of 160° C. and 4 parts by weight of a high-density polyethylene (hereinafter, abbreviated to “HDPE”) showing an MFR of 5 g/10 minutes (measured in accordance with ASTM D 1238, namely, at 190° C. and with a load of 2.16 kg), a density of 0.97 g/cm³, and a melting point of 134° C.

<Manufacturing of Mixed-Continuous-Fiber Nonwoven Fabric>

The above-described TPU-1 and B-1 were melted in separate extruders (each having a diameter of 30 mm). Then, a web was manufactured from a fiber mixture containing continuous fiber containing TPU-1, named Continuous Fiber A, and continuous fiber containing B-1, named Continuous Fiber B, in an apparatus for making spunbonded nonwoven fabric (length perpendicular to the machine direction on the collection surface of the collection belt: 100 mm) equipped with a spinneret, by spunbonding under the conditions with resin and die temperatures of 220° C., a cooling air temperature of 20° C., and a velocity of drawing air of 3000 m/minute, allowed to accumulate on the collection surface of the collection belt. The above-mentioned spinneret had a nozzle pattern in which slits for discharging TPU-1 and those for discharging B-1 were alternately arranged; the nozzle diameter was 0.6 mm, the nozzle pitch was 8 mm both in the machine direction and in the cross direction, and the ratio of the number of nozzles for Fiber A to that of nozzles for Fiber B was 1:3. The discharge rate per slit was set at 0.6 g/(minute·slit) for both Fiber A and Fiber B.

The web of a continuous-fiber mixture, which had accumulated on the collection surface of the collection belt, was nipped with a nipping roller (preheated to 80° C.) coated with a nonadhesive material at a line pressure of 10 kg/cm. The mixed-fiber spunbonded nonwoven fabric obtained (i.e., the above-described web of a continuous-fiber mixture) was heated and pressurized with an argyle embossing roller (percentage of embossed area: 20.6%; temperature of embossing: 120° C.), yielding mixed-continuous-fiber nonwoven fabric with a basis weight of 25 g/m².

Then, this mixed-continuous-fiber nonwoven fabric was further drawn, yielding nonwoven fabric with a higher bulkiness (thickness/basis weight). More specifically, this drawing process was carried out by gear drawing (FIG. 7). This gear drawing process was carried out in such a manner that the relationship between the draw ratio represented by gear height (H) mm and gear width (W) mm and the maximum percentage of elongation (E) % obtained through measurement according to the strip method specified in L-1096 would meet the following formula (Chemical Formula 1).

$$\frac{\sqrt{{( W / 2 )}^{2} + {H}^{2}} - ( W / 2 )}{( W / 2 )} \times 100 \geq E ( \% ) \qquad [ Chemical Formula 1 ]$$

More specifically, the mixed-continuous-fiber nonwoven fabric, which had been heated and pressurized with an argyle embossing roller, was drawn at a draw ratio in the cross direction of 60% by passing through the gear-drawing machine shown in FIG. 7 (gear width: 5 mm; distance between points to fix the nonwoven fabric web: 2.5 mm), yielding a sheet for barrier leg cuffs made from continuous-fiber nonwoven fabric (B) comprising a fiber mixture.

The characteristics of the sheet for barrier leg cuffs obtained were measured in the ways described earlier. The measurements are shown in Table 1.

### Example 5

The eccentric-hollow-conjugated-continuous-fiber nonwoven fabric obtained in Example 1, a deposit on a collection belt, was covered with a sheet of melt-blown nonwoven fabric using an apparatus for manufacturing melt-blown, with the target basis weight set at 4 g/m², yielding a laminate. Note that this melt-blown nonwoven fabric was obtained in the following way: a polypropylene homopolymer [MFR (measured in accordance with JIS K7210-1999, namely, at 230° C. and with a load of 2.16 kg): 900 g/10 minutes] was melted and extruded at a temperature of 300° C. while being pelletized and solidified with heating air discharged from both sides of the nozzles, and then the filaments obtained, which had an average fiber diameter of approximately 3 were laminated.

Then, the nonwoven fabric laminate obtained was heated and pressurized with a quilt embossing roller (percentage of embossed area: 9.7%; temperature of embossing: 125° C.), yielding a sheet for barrier leg cuffs that had a basis weight of 29 g/m² and took the layered structure of melt-blown nonwoven fabric layer/eccentric-hollow-conjugated-continuous-fiber nonwoven fabric layer.

The characteristics of the sheet for barrier leg cuffs obtained were measured in the ways described earlier. The measurements are shown in Table 1. It should be noted that the degrees of air permeability indicated are values for a laminate of a total basis ratio of 25 g/m² converted from those for the above-described laminate, which had a basis ratio of 29 g/m², according to the following formula 1.

[Formula 1]

Y=−2.0882X+451.21 (Formula 1)

Y: degree of air permeability (cc/cm²/second); X: basis weight (g/m²)

### Example 6

### Manufacturing of Mixed-Continuous-Fiber Nonwoven Fabric

The above described TPU-1 and thermoplastic resin composition (B-1) were melted in separate extruders having a diameter of 75 mm and that having a diameter of 50 mm, respectively. Then, a web was manufactured from a fiber mixture containing continuous fiber containing TPU-1, named Continuous Fiber A, and continuous fiber containing B-1, named Continuous Fiber B, in an apparatus for making spunbonded nonwoven fabric (length perpendicular to the machine direction on the collection surface of the collection belt: 800 mm) equipped with a spinneret, by spunbonding under the conditions with resin and die temperatures of 210° C., a cooling air temperature of 20° C., and a velocity of drawing air of 3750 m/minute, allowed to accumulate on the collection surface of the collection belt. The above-mentioned spinneret had a nozzle pattern in which slits for discharging TPU-1 and those for discharging B-1 were alternately arranged; the diameter of nozzles for TPU-1 (Fiber A) was 0.75 mm, the diameter of nozzles for B-1 (Fiber B) was 0.6 mm, the nozzle pitch was 8 mm in the machine direction and 11 mm in the cross direction, and the ratio of the number of nozzles for Fiber A to that of nozzles for Fiber B was 1:1.45. The discharge rate per slit was set at 0.6 g/(minute·slit) for both Fiber A and Fiber B.

The web of a continuous-fiber mixture, which had accumulated on the collection surface of the collection belt, was (nipped) with a nipping roller (preheated to 80° C.) coated with a nonadhesive material at a line pressure of 10 kg/cm. The mixed-fiber spunbonded nonwoven fabric obtained (i.e., the above-described web of a continuous-fiber mixture) was heated and pressurized with an argyle embossing roller (percentage of embossed area: 18.0%; temperature of embossing: 120° C.), yielding mixed-continuous-fiber nonwoven fabric with a basis weight of 25 g/m². Then, this mixed-continuous-fiber nonwoven fabric was further drawn, yielding nonwoven fabric with a higher bulkiness (thickness/basis weight). More specifically, this drawing process was carried out by gear drawing (FIG. 7). This gear drawing process was carried out in such a manner that the relationship between the draw ratio represented by gear height (H) mm and gear width (W) mm and the maximum percentage of elongation (E) % obtained through measurement according to the strip method specified in L-1096 would meet the formula (Chemical Formula 1) mentioned earlier.

More specifically, the mixed-continuous-fiber nonwoven fabric, which had been heated and pressurized with an argyle embossing roller, was drawn at a draw ratio in the cross direction of 80% by passing through the gear-drawing machine shown in FIG. 7 (gear width: 2.5 mm; distance between points to fix the nonwoven fabric web: 1.25 mm), yielding a sheet for barrier leg cuffs made from continuous-fiber nonwoven fabric (B) comprising a fiber mixture.

The characteristics of the sheet for barrier leg cuffs obtained were measured in the ways described earlier. The measurements are shown in Table 1.

### Comparative Example 1

A propylene polymer showing an MFR of 60 g/10 minutes measured at 230° C. with a load of 2160 g [melting point (Tmo): 157° C.], a thermoplastic resin, was melted in an extruder (having a diameter of 30 mm). Then, non-crimped conjugated-continuous-fiber nonwoven fabric was manufactured in the apparatus for making nonwoven fabric shown in FIG. 2 (a spunbonding machine; length perpendicular to the machine direction on the collection surface: 100 mm). This apparatus had a spinneret positioned so as to discharge non-crimped fiber. More specifically, the discharged non-crimped fiber, which comprises the higher melting-point thermoplastic resin, was melted and spun by spunbonding under the conditions with resin and die temperatures of 210° C., a cooling air temperature of 25° C., and a velocity of drawing air of 2000 m/minute, allowed to accumulate on the collection surface of the collection belt. This yielded non-crimped-conjugated-continuous-fiber nonwoven fabric with a basis weight of 12.5 g/m².

In addition, the above-mentioned spinneret had a nozzle diameter of 0.6 mm and nozzle pitches of 8 mm and 9 mm in the machine direction and cross direction, respectively. The discharge rate per slit was set at 0.6 g/(minute·slit).

Then, the non-crimped-conjugated-continuous-fiber nonwoven fabric obtained was heated and pressurized with a quilt embossing roller (percentage of embossed area: 24.0%; temperature of embossing: 125° C.), yielding a sheet for barrier leg cuffs made from non-crimped-conjugated-continuous-fiber nonwoven fabric with a basis weight of 25 g/m².

The characteristics of the sheet for barrier leg cuffs obtained were measured in the ways described earlier. The measurements are shown in Table 1.

### Comparative Example 2

A sheet for barrier leg cuffs made from continuous-fiber nonwoven fabric with a basis weight of 25 g/m² was obtained in the same way as Example 1 except that heating and pressurizing of the conjugated continuous fiber was carried out using an argyle embossing roller (percentage of embossed area: 20.6%; temperature of embossing: 125° C.) instead of the quilt embossing roller (percentage of embossed area: 9.7%; temperature of embossing: 125° C.)

The characteristics of the sheet for barrier leg cuffs obtained were measured in the ways described earlier. The measurements are shown in Table 1.

### Comparative Example 3

A sheet for barrier leg cuffs made from continuous-fiber nonwoven fabric with a basis weight of 25 g/m² was obtained in the same way as Example 2 except that heating and pressurizing of the conjugated continuous fiber was carried out using (percentage of embossed area: 20.6%; temperature of embossing: 125° C.) obtained via treatment with an argyle embossing roller instead of the quilt embossing roller (percentage of embossed area: 9.7%; temperature of embossing: 125° C.)

The characteristics of the sheet for barrier leg cuffs obtained were measured in the ways described earlier. The measurements are shown in Table 1.

### Comparative Example 4

Higher melting-point thermoplastic resin: A propylene homopolymer (MFR measured at 230° C. under a load of 2160 g: 60 g/10 minutes; melting point (Tmo): 157° C.)

Lower melting-point thermoplastic resin: A propylene/ethylene random copolymer (MFR measured at 230° C. under a load of 2160 g: 60 g/10 minutes; Mw/Mn=2.4; melting point (Tmo): 143° C.; ethylene content: 4 mol %)

The above-described higher melting-point thermoplastic resin and lower melting-point thermoplastic resin were melted in separate extruders (each having a diameter of 30 mm) with the molding temperature set at 200° C. Then, a sheet for barrier leg cuffs was manufactured from continuous-fiber nonwoven fabric in the apparatus for making nonwoven fabric shown in FIG. 2 (a spunbonding machine; length perpendicular to the machine direction on the collection surface: 100 mm). This apparatus had a spinneret whose nozzle pitch was 9.1 mm in the machine direction and 8.3 mm in the cross direction, and the spinneret was positioned so that the fiber section shown in FIG. 6 could be obtained. More specifically, the manufacturing procedure was as follows. The higher melting-point thermoplastic resin and lower melting-point thermoplastic resin were spun into crimped conjugated continuous fiber through a spinneret for crimped conjugated fiber that gives the cross-sectional shape shown in FIG. 6, with the weight ratio of the higher melting-point thermoplastic resin to the lower melting-point thermoplastic resin set at 50/50. The crimped conjugated continuous fiber spun was drawn at a yarn speed of 2500 m/minute under cooling with air (25° C.), allowed to accumulate on the collection belt. Then, the deposit obtained was heated and pressurized with a quilt embossing roller (percentage of embossed area: 24.0%; temperature of embossing: 120° C.), yielding a sheet for barrier leg cuffs made from continuous-fiber nonwoven fabric with a basis weight of 25 g/m².

The characteristics of the sheet for barrier leg cuffs obtained were measured in the ways described earlier. The measurements are shown in Table 1.

### Comparative Example 5

The continuous-fiber nonwoven fabric obtained in Comparative Example 1 was covered with a sheet of melt-blown nonwoven fabric with a basis weight of 4 g/m² in the same way as Example 5, yielding a laminate. Then, this sheet of melt-blown nonwoven fabric was covered with a sheet of the continuous-fiber nonwoven fabric obtained in Comparative Example 1 to make a laminate. Then, the obtained laminate was processed with an argyle embossing roller (percentage of embossed area: 20.6%; temperature of embossing: 125° C.), yielding a sheet for barrier leg cuffs made from a continuous-fiber nonwoven fabric/melt-blown nonwoven fabric/continuous-fiber nonwoven fabric (S/M/S) laminate with a basis weight of 54 g/m².

The characteristics of the sheet for barrier leg cuffs obtained were measured in the ways described earlier. The measurements are shown in Table 1.

### Reference Example 1

Nonwoven fabric was manufactured from the thermoplastic resin composition (B-1) described in Example 4 under the same conditions as for Example 1. The degree of elongation was measured to be 130%.

TABLE 1

| | Example | Example | Example | Example | Example | Example |
|---|---|---|---|---|---|---|
| | 1 | 2 | 3 | 4 | 5 | 6 |
| Basis weight | 25 | 25 | 25 | 25 | 29 | 25 |
| (g/m²) | | | | | | |
| Embossed | Quilt | Quilt | Quilt | Argyle | Quilt | Argyle |
| pattern | | | | | | |
| Percentage of | 9.7 | 9.7 | 9.7 | 20.6 | 9.7 | 18 |
| embossed area | | | | | | |
| Distance | 5.9 | 5.9 | 5.9 | 1.5 | 5.9 | 1.5 |
| between | | | | | | |
| embossed | | | | | | |
| patterns (mm) | | | | | | |
| No. of crimps | 29 | 23 | 19 | 0 | 29 | 0 |
| Water | 70 | 72 | 75 | 80 | 200 | 80 |
| resistance | | | | | | |
| Air permeability | 377 | 327 | 349 | 400 | 100 | 400 |
| Thickness/basis | 0.021 | 0.016 | 0.019 | 0.021 | 0.020 | 0.021 |
| weight | | | | | | |
| Performance in | ∘ | ∘ | ∘ | ∘ | ∘ | ∘ |
| preventing | | | | | | |
| loose feces | | | | | | |
| effusion | | | | | | |

| | Comparative | Comparative | Comparative | Comparative | Comparative |
|---|---|---|---|---|---|
| | Example 1 | Example 2 | Example 3 | Example 4 | Example 5 |
| Basis weight | 25 | 25 | 25 | 25 | 54 |
| (g/m²) | | | | | |
| Embossed | Quilt | Argyle | Argyle | Quilt | Argyle |
| pattern | | | | | |
| Percentage of | 9.7 | 20.6 | 20.6 | 9.7 | 20.6 |
| embossed area | | | | | |
| Distance | 5.9 | 1.5 | 1.5 | 5.9 | 1.5 |
| between | | | | | |
| embossed | | | | | |
| patterns (mm) | | | | | |
| No. of crimps | 0 | 29 | 23 | 14 | 0 |
| Water | 80 | 80 | 82 | 65 | 220 |
| resistance | | | | | |
| Air permeability | 287 | 233 | 232 | 257 | 40 |
| Thickness/basis | 0.016 | 0.012 | 0.017 | 0.014 | 0.015 |
| weight | | | | | |
| Performance in | x | x | x | x | ∘ |
| preventing | | | | | |
| loose feces | | | | | |
| effusion | | | | | |

As clearly seen in Table 1, Examples 1 to 4 and 6, sheets for barrier leg cuffs made of continuous-fiber nonwoven fabric showing a degree of air permeability of not less than 300 cc/cm²/second and a ratio of thickness to basis weight of not lower than 0.015 mm/(g/m²), were superior in air permeability and free from the effusion of loose feces.

Also, Example 5, a sheet for barrier leg cuffs obtained as a laminate of the sheet for barrier leg cuffs obtained in Example 1 and a sheet of mel-blown nonwoven fabric, was inferior in air permeability to the other examples but superior to Comparative Example 5, a sheet for barrier leg cuffs made from an S/M/S nonwoven fabric laminate.

On the other hand, Comparative Examples 1 and 3, sheets for barrier leg cuffs showing a ratio of thickness to basis weight of not lower than 0.015 mm/(g/m²) but showing a degree of air permeability less than 300 cc/cm²/second, were inferior in performance in preventing the effusion of loose feces (loose feces effusion prevention efficacy).

Also, Comparative Examples 2 and 4, sheets for barrier leg cuffs showing a degree of air permeability of not more than 300 cc/cm²/second and a ratio of thickness to basis weight of not more than 0.015 mm/(g/m²), were inferior in performance in preventing the effusion of loose feces (loose feces effusion prevention efficacy).

### INDUSTRIAL APPLICABILITY

The sheet for barrier leg cuffs according to the present invention, made from continuous-fiber nonwoven fabric, is excellent in terms of bulkiness, air permeability, and performance in preventing the leakage of low-viscosity solution; thus, it is suitable for use as barrier leg cuffs of disposable diapers, sanitary napkins, and other hygienic materials.

1. A sheet for a barrier leg cuff comprising a continuous-fiber nonwoven fabric having a ratio of thickness to basis weight equal to or higher than 0.015 mm/(g/m²).

2. The sheet for a barrier leg cuff according to claim 1, wherein the continuous-fiber nonwoven fabric comprises a fiber mixture of a thermoplastic elastomer continuous fiber and an extensible continuous fiber.

3. The sheet for a barrier leg cuff according to claim 2, wherein the percentage of embossed area is in the range of 10 to 25%.

4. The sheet for a barrier leg cuff according to claim 2, wherein the extensible continuous fiber is a nonwoven fabric having a degree of elongation (%) of at least 50%.

5. The sheet for a barrier leg cuff according to claim 1, wherein the continuous-fiber nonwoven fabric is a continuous-fiber nonwoven fabric having a basis weight in the range of 5 to 30 g/m².

6. The sheet for a barrier leg cuff according to claim 1, having a degree of air permeability equal to or higher than 300 cc/cm²/second when the basis weight thereof is 25 g/m².

7. The sheet for a barrier leg cuff according to atm-one of claim 1, wherein the continuous-fiber nonwoven fabric is a continuous-fiber nonwoven fabric having a degree of water resistance equal to or higher than 60 mmH₂O.

8. A composite sheet for a barrier leg cuff comprising a laminate containing the sheet for a barrier leg cuff according to claim 1 and a melt-blown nonwoven fabric having a basis weight in the range of 0.5 to 5 g/m².

9. The sheet for a barrier leg cuff according to claim 3, wherein the extensible continuous fiber is a nonwoven fabric having a degree of elongation (%) of at least 50%.

10. The sheet for a barrier leg cuff according to claim 9, wherein the continuous-fiber nonwoven fabric is a continuous-fiber nonwoven fabric having a basis weight in the range of 5 to 30 g/m².

11. The sheet for a barrier leg cuff according to claim 10, having a degree of air permeability equal to or higher than 300 cc/cm²/second when the basis weight thereof is 25 g/m².

12. The sheet for a barrier leg cuff according to claim 11, wherein the continuous-fiber nonwoven fabric is a continuous-fiber nonwoven fabric having a degree of water resistance equal to or higher than 60 mmH₂O.

13. A composite sheet for a barrier leg cuff comprising a laminate containing the sheet for a barrier leg cuff according to claim 12 and a melt-blown nonwoven fabric having a basis weight in the range of 0.5 to 5 g/m².
